(19) United States
(12) Patent Application Publication
(10) Pub. No.: US 2024/0231886 A1
(43) Pub. Date: Jul. 11, 2024

(54) METHOD FOR PROCESSING TASK, ELECTRONIC DEVICE AND STORAGE MEDIUM

(71) Applicant: BEIJING DAJIA INTERNET INFORMATION TECHNOLOGY CO., LTD., Beijing (CN)

(72) Inventor: Jie WANG, Beijing (CN)

(21) Appl. No.: 18/240,726

(22) Filed: Aug. 31, 2023

(30) Foreign Application Priority Data
Jan. 9, 2023 (CN) 202310028459.1

(51) Int. Cl. G06F 9/48

(52) U.S. Cl. CPC G06F 9/48

(57) ABSTRACT

A method for processing a task is performed by an electronic device. The method includes: in response to receiving a display instruction of a subtask in a target task, displaying a subtask page, wherein the subtask page includes a plurality of pieces of material identity information, the plurality of pieces of material identity information include first material identity information corresponding to a first picture type and second material identity information corresponding to a second picture type, the first material identity information indicates that an object to be captured is captured by a capturing assembly for picture acquisition; and the second material identity information indicates that a target picture is acquired from a picture storage region; and in response to receiving an operation instruction corresponding to target material identity information in the plurality of pieces of material identity information, displaying a generated work of the subtask on the subtask page.

### CROSS REFERENCE TO RELATED APPLICATIONS

This application is based on and claim priority to Chinese Patent Application No. 202310028459.1, filed on Jan. 9, 2023, the content of which is incorporated herein by reference in its entirety.

### TECHNICAL FIELD

The present disclosure relates to afield of Internet technologies, and particularly to a method for processing a task, an electronic device and a storage medium.

### BACKGROUND

With rapid development of a current mobile Internet, propagation of information based on a mobile terminal has become increasingly mature. Generally, the information may be embedded in various browsers or applications on the terminal for propagation.

### SUMMARY

According to a first aspect of the present disclosure, a method for processing a task is performed by an electronic device, and the method includes:
in response to receiving a display instruction of a current subtask in a target task, displaying a subtask page, in which the subtask page includes a plurality of pieces of material identity information, the plurality of pieces of material identity information include first material identity information corresponding to a first picture type and second material identity information corresponding to a second picture type, the first material identity information indicates that an object to be captured is captured by a capturing assembly for picture acquisition, and the second material identity information indicates that a target picture is acquired from a picture storage region; and
in response to receiving an operation instruction corresponding to target material identity information in the plurality of pieces of material identity information, displaying a generated work of the current subtask on the subtask page;
in which the generated work includes material information carried in the target material identity information and the object to be captured, or the generated work includes material information carried in the target material identity information and the target picture.

According to a second aspect of the present disclosure, an electronic device includes: a processor; and a memory configured for storing instructions executable by the processor. The processor is configured to in response to receiving a display instruction of a current subtask in a target task, display a subtask page, in which the subtask page includes a plurality of pieces of material identity information, the plurality of pieces of material identity information include first material identity information corresponding to a first picture type and second material identity information corresponding to a second picture type, the first material identity information indicates that an object to be captured is captured by a capturing assembly for picture acquisition, and the second material identity information indicates that a target picture is acquired from a picture storage region; and in response to receiving an operation instruction corresponding to target material identity information in the plurality of pieces of material identity information, display a generated work of the current subtask on the subtask page, in which the generated work includes material information carried in the target material identity information and the object to be captured, or the generated work comprises material information carried in the target material identity information and the target picture.

According to a third aspect of the present disclosure, a non-transitory computer-readable storage medium has instructions stored thereon. When the instructions are executed by a processor of an electronic device, the electronic device is caused to perform the method for processing a task as described in the above first aspect of the present disclosure.

It should be noted that, the above general description and details in the following are exemplary and explanatory, and do not constitute the limitation on the present disclosure.

### BRIEF DESCRIPTION OF THE DRAWINGS

In order to explain the technical solutions in the embodiments of the present disclosure more clearly, the drawings described in the embodiments will be briefly introduced below. The accompanying drawings described as below are only some embodiments of the present disclosure.

Those skilled in the art may obtain other drawings without any creative work based on these accompanying drawings.

FIG. 1 is a diagram illustrating an application environment according to an exemplary embodiment.

FIG. 2 is a flowchart illustrating a method for processing a task according to an exemplary embodiment.

FIG. 3 is a diagram illustrating a target task page according to an exemplary embodiment.

FIG. 4 is a flowchart illustrating a method for determining a plurality of pieces of material identity information according to an exemplary embodiment.

FIG. 5 is a diagram illustrating a subtask display page according to an exemplary embodiment.

FIG. 6 is a flowchart illustrating a method for determining a plurality of pieces of material identity information according to an exemplary embodiment.

FIG. 7 is a diagram illustrating a subtask display page according to an exemplary embodiment.

FIG. 8 is a flowchart illustrating a method for adjusting information according to an exemplary embodiment.

FIG. 9 is a block diagram illustrating an apparatus for processing a task according to an exemplary embodiment.

FIG. 10 is a block diagram illustrating an electronic device for processing a task according to an exemplary embodiment.

### DETAILED DESCRIPTION

The technical solution in the embodiments of the present disclosure will be described clearly and completely in combination with the accompanying drawings in the embodiments of the present disclosure. The embodiments described are only a part of embodiments in the present disclosure, rather than all the embodiments. On the basis of embodiments of the present disclosure, all other embodiments obtained by those skilled in the art without any creative work are within the protection scope of the present disclosure.

It needs to be noted that, the “first”, “second” or similar words used in the specification, the claims and the accompanying drawings of the present disclosure are configured to distinguish similar first objects, rather than describe a specific order or a precedence order. It should be understood that the data used herein may be interchanged where appropriate so that the embodiments of the present disclosure described herein may be implemented in an order other than the orders as illustrated or described herein. The implementations described in the following exemplary embodiments do not represent all implementations consistent with the present disclosure. Rather, they are merely examples of apparatuses and methods consistent with some aspects of the disclosure as detailed in the appended claims.

It should be noted that user information (including but not limited to user equipment information and user personal information) and data (including but not limited to data for display and data for analyzing) involved in the present disclosure are information and data authorized by a user or fully authorized by each party.

A picture or a video is a carrier capable of exchanging and interacting a resource such as information in the current society. When a user makes the picture or the video, the user needs to enter different production pages via different production channels, thereby producing the picture or the video. Even, when different forms of pictures are produced, it is also necessary to enter different production pages via different production channels, so that the user gets bored with a complex production process, thereby affecting information output and expression of the user, and wasting sharing resources.

In view of the above problem, the present disclosure proposes a method for processing a task. In details, a subtask page is displayed in response to receiving a display instruction of a current subtask in a target task, in which the subtask page includes pieces of material identity information. The pieces of material identity information include first material identity information corresponding to a first picture type and second material identity information corresponding to a second picture type. The first material identity information indicates that an object to be captured is captured by a capturing assembly for picture acquisition. The second material identity information indicates that a target picture is acquired from a picture storage region. A generated work of the current subtask is displayed on the subtask page in response to receiving an operation instruction corresponding to target material identity information in the pieces of material identity information, in which the generated work includes material information carried in the target material identity information and the object to be captured, or the generated work includes material information carried in the target material identity information and the target picture.

In this way, material identity information corresponding to different picture types is concentrated in a production channel of one subtask, so that different picture forms of works are produced via the production channel, which enhances a resource utilization and saves user time.

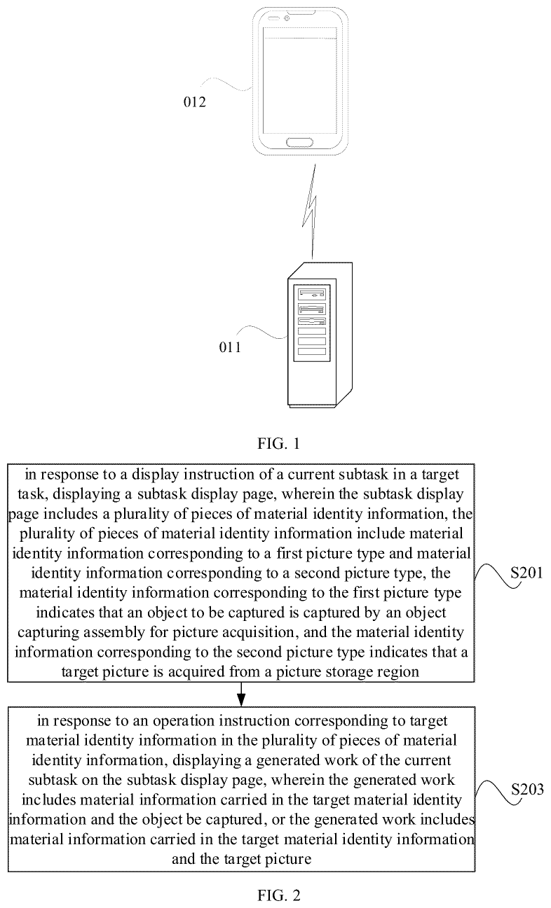

As illustrated in FIG. 1, FIG. 1 is a diagram illustrating an application environment of a method for processing a task according to an exemplary embodiment. The application environment may include a server 011 and a client 012.

In some embodiments, the server 011 may be an independent physical server or a server cluster or a distributed system consisting of a plurality of physical servers, or may be a cloud server that provides cloud services, cloud databases, cloud computing, cloud functions, cloud storage, network services, cloud communications, middleware services, domain name services, security services, content delivery networks (CDN), and basic cloud computing services such as big data and artificial intelligence platforms. An operating system running on the server may include but not limited to an Android system, an IOS system, Linux, Windows and Unix.

In some embodiments, the client 012 may include but not limited to a picture-type client such as a smart phone, a desktop computer, a tablet computer, a notebook computer, a smart speaker, a digital assistant, an augmented reality (AR)/virtual reality (VR) device and a smart wearable device. The client 012 may also be a software running on the client, such as an application (APP) and an applet. Optionally, the operating system running on the client may include but not limited to an Android system, an IOS system, Linux, Windows and Unix.

In some embodiments, the client 012 may display a subtask display page in response to a display instruction of a current subtask in a target task, in which the subtask display page includes a plurality of pieces of material identity information, the plurality of pieces of material identity information include material identity information corresponding to a first picture type and material identity information corresponding to a second picture type, the material identity information corresponding to the first picture type indicates that an object to be captured is captured by an object capturing assembly for picture acquisition, and the material identity information corresponding to the second picture type indicates that a target picture is acquired from a picture storage region; and the client 012 may display a generated work of the current subtask on the subtask display page in response to an operation instruction corresponding to target material identity information in the plurality of pieces of material identity information, in which the generated work includes material information carried in the target material identity information and the object to be captured, or the generated work includes material information carried in the target material identity information and the target picture. In the embodiments of the present disclosure, material identity information corresponding to different picture types is concentrated in a production channel of one subtask, so that different picture forms of works are produced via the production channel, which enhances a resource utilization and saves user time.

In an exemplary implementation, databases corresponding to the client and the server may be node devices in a blockchain system, and may share acquired and generated information to other node devices in the blockchain system, so as to achieve information sharing among a plurality of node devices. The plurality of node devices in the blockchain system may be configured with a same blockchain. The blockchain consists of a plurality of blocks, and there is an association relationship between adjacent blocks, so that tampering data in any block may be detected by a next block, which may prevent the data in the blockchain from being tampered, and ensure security and reliability of the data in the blockchain.

FIG. 2 is a flowchart illustrating a method for processing a task according to an exemplary embodiment. As illustrated in FIG. 2, the method for processing a task is applicable to a client, for example, a mobile device, including a smart mobile phone or an IPAD, or may be a device such as a desktop computer. The flowchart includes the following steps.

At step S201, a subtask display page is displayed in response to a display instruction of a current subtask in a target task. The subtask display page includes a plurality of pieces of material identity information, the plurality of pieces of material identity information include material identity information corresponding to a first picture type and material identity information corresponding to a second picture type, the material identity information corresponding to the first picture type indicates that an object to be captured is captured by an object capturing assembly for picture acquisition, and the material identity information corresponding to the second picture type indicates that a target picture is acquired from a picture storage region.

In the embodiments of the present disclosure, the above target task may be a task that needs to be completed in a certain webpage on the client. Alternatively, the above target task may be a task that needs to be completed in a certain APP on the client. Optionally, the certain APP may be a video APP, a music APP, a social APP and an information query APP. In an embodiment of the present disclosure, the above picture storage region stores a plurality of historical pictures acquired at a historical moment, and the plurality of historical pictures include the above target picture.

It is illustrated by taking the target task being a task that needs to be completed in the certain APP on the client for example. When the client detects a startup instruction of the APP, the APP may be started on the client, to display a home page of the APP. In an optional embodiment, the user may enter the target task page by clicking a component provided on the home page. In another optional embodiment, a search component may be included on the home page of the application, and when the client detects a search box display instruction is triggered based on the search component, the client may display the search box on the home page, and when the client detects an information input instruction, the client may display input information in the search box, and jump from the home page to the target task page when detecting the input information to be searched.

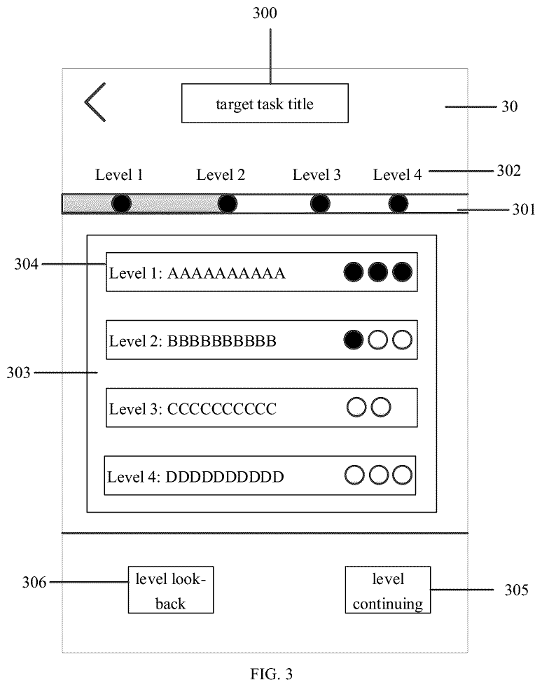

In some embodiments, the client may include information related to the target task. FIG. 3 is a diagram illustrating a target task page according to an exemplary embodiment. As illustrated in FIG. 3, a target task page 30 is included.

Optionally, as illustrated in FIG. 3, the target task page 30 may include a target task title 300. In an optional embodiment, the target task title may be displayed at any position of the target task page 30. For example, in order to quickly and clearly understand information of the target task, the target task title may be displayed at the top of the target task page 30.

In an optional embodiment, the target task may further include one task, such as a video capturing task. In another optional embodiment, the target task may include a plurality of subtasks. As illustrated in FIG. 3, the target task page 30 may include a task progress bar 301, and the plurality of subtasks may be displayed on the task progress bar 301. In an optional embodiment, the client may display subtask identity information 302, such as “level 4” on a node of the task progress bar corresponding to each of the plurality of subtasks.

In the embodiments of the present disclosure, subtask completion information may be displayed on the task progress bar 301. As illustrated in FIG. 3, the task progress bar before the subtask corresponding to “level 2” is filled in gray. Subtask completion information of a subtask corresponding to “level 1” is “progress bars in front and behind are filled in gray”, indicating that the subtask corresponding to the “level 1” has been completed, that is, the subtask corresponding to the “level 1” is a historical subtask. Subtask completion information of a subtask corresponding to “level 2” is “progress bar in front is filled in gray”, indicating that the subtask corresponding to the “level 2” is in progress, that is, the subtask corresponding to the “level 2” is a current subtask. Subtask completion information of a subtask corresponding to “level 3” is “progress bars in front and behind are not filled in gray”, indicating that the subtask corresponding to the “level 3” has not been completed or has not been unlocked, that is, the subtask corresponding to the “level 3” is a future subtask. Similarly, subtask completion information of a subtask corresponding to “level 4” is “progress bars progress bars in front and behind are not filled in gray”, indicating that the subtask corresponding to the “level 4” has not been completed or has not been unlocked, that is, the subtask corresponding to the “level 4” is a future subtask.

In an optional embodiment, the target task page 30 may include a subtask information display area 303. Optionally, the client may display information 304 related to each subtask in the subtask information display area 303. For example, the client may display a title of each subtask in the subtask information display area 303. For example, a tile of the subtask corresponding to the “level 1” is “AAAAAAAAAA”.

Alternatively, the client may display a number of steps and a completion status of each subtask in the subtask information display area 303. For example, according to three circles filled in black located behind the title of the subtask corresponding to the “level 1”, it can be seen that the subtask corresponding to the “level 1” includes three steps, and the three steps have been completed. This also proves from another side that the subtask corresponding to the “level 1” has been completed, that is, the subtask corresponding to the “level 1” is a historical subtask. According to one circle filled in black located behind the title of the subtask corresponding to the “level 2” and two circles not filled in black located behind the title of the subtask corresponding to the “level 2”, it can be seen that the subtask corresponding to the “level 2” includes three steps, and a first step has been completed. This also proves from another side that the subtask corresponding to the “level 2” is in progress, that is, the subtask corresponding to the “level 2” is a current subtask. According to two circles not filled in black located behind the title of the subtask corresponding to the “level 3”, it can be seen that the subtask corresponding to the “level 3” includes two steps, and no step has been completed. This also proves from another side that the subtask corresponding to the “level 3” has not been completed or has not been unlocked, that is, the subtask corresponding to the “level 3” is a future subtask.

In the embodiments of the present disclosure, not only understanding of a task progress may be deepened from a plurality of perspectives, but also a condition that requires to be satisfied for each subtask may be viewed clearly by presenting the task progress bar 301 and the subtask information display area 303, which reduces the user time of understanding the task, and enhances the user experience.

In an optional embodiment, the target task page 300 further includes a component area. The component area may include a virtual component “level continuing” 305 and a virtual component “level look-back” 306.

In an optional embodiment, the client may display a subtask display page corresponding to a current subtask in response to detecting that the virtual component “level continuing” 305 is clicked. That is, the client may display the subtask display page in response to a display instruction of the current subtask in the target task. When the current subtask includes a plurality of steps, and two steps are not completed, the client may display a subtask display page corresponding to the first of the two steps not completed in the current subtask in response to the display instruction of the current subtask in the target task.

In an optional embodiment, in response to detecting that the virtual component “level look-back” 306 is clicked, the client may display a published work corresponding to a historical subtask before the current subtask. Alternatively, when it is detected that the historical subtask (such as a circle corresponding to the first step in the historical subtask corresponding to the “level 1”) is clicked and the virtual component “level look-back” 306 is also clicked, the client may display a published work corresponding to the first step in the historical subtask corresponding to the “level 1”. That is, the client may play back a published work corresponding to the historical subtask or a published work corresponding to any step in the historical subtask by the virtual component “level look-back” 306.

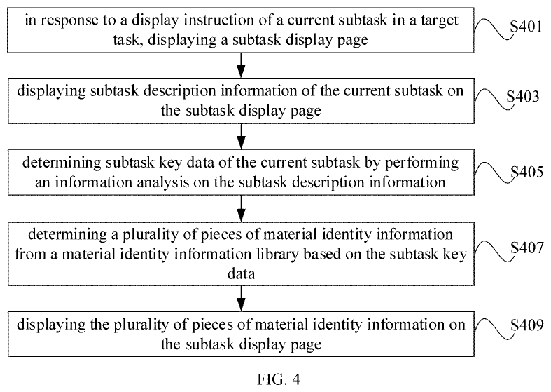

In the embodiments of the disclosure, in response to the display instruction of the current subtask in the target task, the client may display a subtask display page including the plurality of pieces of material identity information. FIG. 4 is a flowchart illustrating a method for determining a plurality of pieces of material identity information according to an exemplary embodiment. As illustrated in FIG. 4, the method includes the following steps.

At step S401, the subtask display page is displayed in response to the display instruction of the current subtask in the target task.

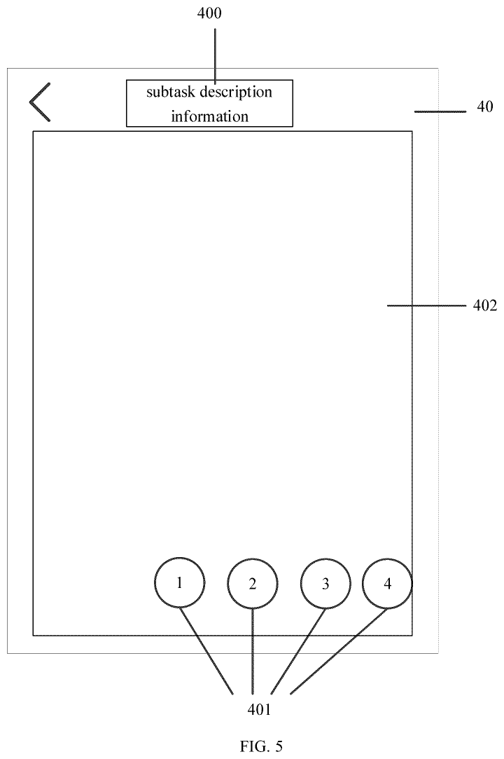

FIG. 5 is a diagram illustrating a subtask display page according to an exemplary embodiment. As illustrated in FIG. 5, in response to the display instruction of the current subtask in the target task, the client may jump from a target task page to a subtask display page 40.

At step S403, subtask description information of the current subtask is displayed on the subtask display page.

As illustrated in FIG. 5, in the embodiments of the present disclosure, the client may display subtask description information of the current subtask or step description information of a current step in the current subtask in the subtask display page 40. Optionally, the subtask description information and the step description information represent contents that may be expressed by the operation completed by the current subtask or the current step in the current subtask. For example, when the current subtask or the current step in the current subtask is “preparing special purchases for the Spring Festival”, the operation required to be completed by the current subtask or the current step in the current subtask needs to be associated with “the Spring Festival” and “special purchases”.

At step S405, subtask key data of the current subtask is determined by performing an information analysis on the subtask description information.

In an optional embodiment, the client may determine subtask key data of the current subtask or step key data of the current step by performing an information analysis on the subtask description information or the step description information. Optionally, the client may determine nouns in the subtask description information or the step description information as the subtask key data of the current subtask or the step key data of the current step by performing a part-of-speech information analysis on the subtask description information or the step description information. For example, two nouns “the Spring Festival” and “special purchases” from the “preparing special purchases for the Spring Festival” may be determined as the subtask key data of the current subtask or the step key data of the current step.

At step S407, the plurality of pieces of material identity information are determined from the material identity information library based on the subtask key data.

In the embodiments of the present disclosure, each piece of material identity information in the material identity information library is configured with a corresponding keyword, and the client may match the subtask key data (or the step key data) with the keyword corresponding to each piece of the material identity information, and determine the material identity information corresponding to the keyword having a match value satisfying a preset value as one of the plurality of pieces of material identity information, so that the client may obtain the plurality of pieces of material identity information.

At step S409, the plurality of pieces of material identity information are displayed on the subtask display page.

Optionally, as illustrated in FIG. 5, the client may display the plurality of pieces of material identity information in an object preview area 402 on a subtask display page 401.

In the embodiments of the disclosure, the client obtains subtask key data or step key data by analyzing the subtask description information or the step description information, thereby determining a plurality of pieces of material identity information that well match the subtask description information or the step description information from the material identity information library, so that the generated work may match the description information better to obtain works having a consistence between a literal expression and other forms of expression.

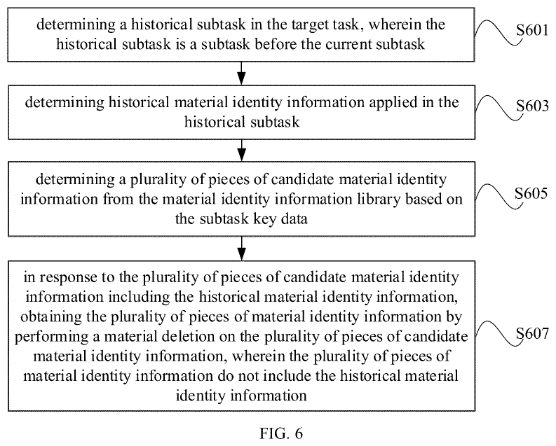

Since there are a plurality of subtasks in the target task, in order to reduce the possibility that works obtained by different subtasks are identical, and enhance diversity and breadth of works, FIG. 6 is a flowchart illustrating a method for determining a plurality of pieces of material identity information according to an exemplary embodiment. As illustrated in FIG. 6, the method includes the following steps.

At step S601, a historical subtask in the target task is determined. The historical subtask is a subtask before the current subtask.

In the embodiments of the disclosure, the client may display a historical subtask before the current subtask in the target task. For example, when the subtask corresponding to the “level 2” is a current subtask, that is, the subtask corresponding to the “level 1” is a historical subtask.

At step S603, historical material identity information applied in the historical subtask is determined.

In the embodiments of the present disclosure, the client may determine the historical material identity information applied in the historical subtask. For example, the historical material identity information includes “001” material identity information in the material identity information library.

At step S605, a plurality of pieces of candidate material identity information are determined from the material identity information library based on the subtask key data.

In the embodiments of the present disclosure, each piece of material identity information in the material identity information library is configured with a corresponding keyword, and the client may match the subtask key data (or the step key data) with the keyword corresponding to each piece of the material identity information, and determine the material identity information corresponding to the keyword having a match value satisfying a preset value as one of the plurality of pieces of candidate material identity information, so that the client may obtain the plurality of pieces of candidate material identity information.

At step S607, in response to the plurality of pieces of candidate material identity information including the historical material identity information, the plurality of pieces of material identity information are obtained by performing a material deletion on the plurality of pieces of candidate material identity information. The plurality of pieces of material identity information do not include the historical material identity information.

In the embodiments of the present disclosure, in response to the plurality of pieces of candidate material identity information including the historical material identity information, the client may obtain the plurality of pieces of material identity information by performing the material deletion on the plurality of pieces of candidate material identity information. The plurality of pieces of material identity information do not include the historical material identity information.

In this way, a check of the historical material identity information may ensure that different subtasks may correspond to different material identity information, so that there is no duplication in a final generated work.

At step S203, a generated work of the current subtask is displayed on the subtask display page in response to an operation instruction corresponding to target material identity information in the plurality of pieces of material identity information. The generated work includes material information carried in the target material identity information and the object to be captured, or the generated work includes material information carried in the target material identity information and the target picture.

In the embodiments of the present disclosure, in response to the operation instruction corresponding to target material identity information in the plurality of pieces of material identity information, the client may display the generated work of the current subtask on the subtask display page.

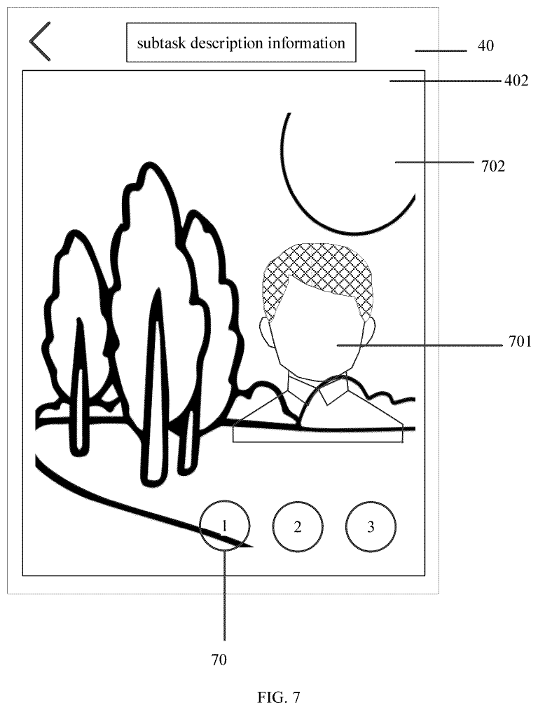

In an optional embodiment, the generated work includes material information carried in the target material identity information and the object to be captured. When the target material identity information is material identity information corresponding to a first picture type, FIG. 7 is a diagram illustrating a subtask display page according to an exemplary embodiment. As illustrated in FIG. 7, in response to the operation instruction corresponding to the target material identity information 70 in the plurality of pieces of material identity information, the client may display the object to be captured in a first preview area 701 of the subtask display page 40, and may display material information carried in the target material identity information in a second preview area 702 of the subtask display page. The first preview area 701 and the second preview area 702 constitute the object preview area 402, and the second preview area 702 is a remaining area of the object preview area 402 after removing the first preview area 701. As illustrated in FIG. 7, an area within a character outline is the first preview area, and an area outside the character outline is the second preview area.

Specifically, when the client detects that a position of the target material identity information 70 is clicked, the client may display the material information carried in the target material identity information in the second preview area. As illustrated in FIG. 7, the material information carried in the target material identity information includes sun, three trees, bush and an upper body of a person who is blank within an outline. Optionally, the client may call an object capturing assembly on the client to capture the user's face, obtain the user's face, and present the user's face in the first preview area.

In the embodiments of the present disclosure, the client may adjust the object to be captured presented in the first preview area. For example, in response to an adjustment instruction of a target sub-object in the object to be captured, the client may display the adjusted object to be captured in the first preview area.

Optionally, the client may display a plurality of different types of object adjustment controls. Taking the object to be captured being a face for example, the object adjustment controls may be a nasal wing adjustment control for adjusting a width of the nasal wing, a nasal bridge adjustment control for adjusting a height of the nasal bridge, a silkworm adjustment control for adjusting a size of the silkworm, an apple muscle adjustment control for adjusting a position of the apple muscle, an eyelid adjustment control for adjusting a width of the eyelid, a lid adjustment control for adjusting a thickness of the lip, a mandibular line adjustment control for adjusting a radian of the mandibular line, and an adjustment control for adjusting the brightness of the face.

Optionally, the object adjustment control may be an adjustment control of a single part, or may be an adjustment control of a combination of a plurality of parts, for example, a first integrated adjustment control for adjusting the width of the nasal wing and the height of the nasal bridge, a second integrated adjustment control for adjusting the size of the silkworm and the width of the eyelid, and a third integrated adjustment control for adjusting the thickness of lip and the radian of the mandibular line.

In an optional embodiment, the client may add a sub-object to the object to be captured presented in the first preview area, and display the added object to be captured in the first preview area. Taking the object to be captured being a face for example, if there are no glasses on the face, the client may add virtual glasses to an eye area of the object to be captured based on a virtual glasses adding instruction.

In the embodiments of the present disclosure, in response to a work generating instruction, the client may display a generated work including the material information and the adjusted object to be captured (or the added object to be captured) in the subtask display page.

In an optional embodiment where the object to be captured is displayed in the first preview area of the subtask display page in response to the operation instruction corresponding to the target material identity information in the plurality of pieces of material identity information, the client may jump from the subtask display page to a work example page in response to the operation instruction corresponding to the target material identity information in the plurality of pieces of material identity information, and display a capturing assembly and published works corresponding to different accounts on the work example page. The published works corresponding to the different accounts are generated based on the target material identity information. That is, the published works corresponding to the different accounts carry material information corresponding to the target material identity information, and the difference among the published works may be that the objects to be captured in the first preview area are different. Subsequently, in response to a capturing instruction triggered based on a capturing assembly, the client may display the object to be captured in the first preview area of the subtask display page and display material information carried in the target material identity information in the second preview area 702 of the subtask display page.

In an optional embodiment, before the generated work including the material information and the adjusted object to be captured (or the added object to be captured) is displayed on the subtask display page in response to the work generating instruction, the client may adjust information presented in both the first preview area and the second preview area, based on a pose adjustment of the object to be captured.

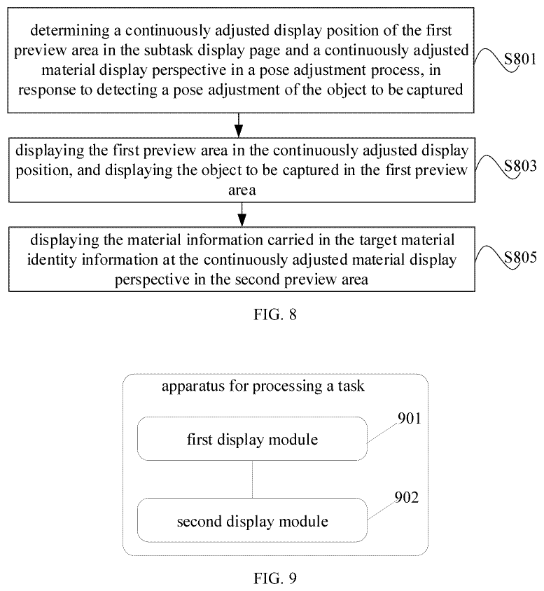

FIG. 8 is a flowchart illustrating a method for adjusting information according to an exemplary embodiment. As illustrated in FIG. 8, the method includes the following steps.

At step S801, in response to detecting a pose adjustment of the object to be captured, a continuously adjusted display position of the first preview area in the subtask display page and a continuously adjusted material display perspective are determined in a pose adjustment process.

In the embodiments of the present disclosure, when a pose adjustment to the object to be captured is detected, the client may determine the continuously adjusted display position of the first preview area in the subtask display page and the continuously adjusted material display perspective in a pose adjustment process.

Optionally, when it is detected that the object to be captured moves upwards, the client may determine that the display position of the first preview area in the subtask display page is continuously adjusted upwards in a pose adjustment process. For example, the display position is continuously adjusted from a lower left corner of the object preview area to an upper right corner.

Optionally, when it is detected that the object to be captured is turning left, the client may determine the continuously adjusted material display perspective in the second preview area in the pose adjustment process.

Specifically, when it is detected that the object to be captured moves leftwards while moving upwards, the client may determine that the display position of the first preview area in the subtask display page is continuously adjusted upwards in the pose adjustment process and the continuously adjusted material display perspective presented in the second preview area.

At step S803, the first preview area in the continuously adjusted display position is displayed, and the object to be captured in the first preview area is displayed.

Optionally, the client may display the first preview area in the continuously adjusted display position, and display the object to be captured in the first preview area.

At step S805, the material information carried in the target material identity information is displayed at the continuously adjusted material display perspective in the second preview area.

Optionally, the client may display the material information carried in the target material identity information at the continuously adjusted material display perspective in the second preview area.

Based on the above solution, the client may flexibly adjust a position of the first preview area in the object preview area as a pose adjustment of the object to be captured, so that a preview picture is presented in a variety of forms. At the same time, pictures from different display perspectives may be acquired in a work generating process based on the continuously adjusted material display perspective, so that a video consisting of pictures from different display perspectives may be generated.

In another optional embodiment, the generated work may include material information carried in the target material identity information and a target picture.

In the embodiments of the present disclosure, when the target material identity information is the material identity information corresponding to the second picture type, in response to the operation instruction corresponding to the target material identity information in the plurality of pieces of material identity information, the client may jump from the subtask display page to a picture display page of a client. The subtask display page is a page in an APP, and the picture display page is a picture display page in a picture storage library (such as an “album”) carried by the client. Alternatively, the picture display page is a page in the APP. Optionally, the client may display a plurality of historical pictures acquired at a historical moment in the picture display page; and display the target picture on the subtask display page in an application sequence of the target picture, in response to an application instruction corresponding to the target picture in the plurality of historical pictures. Optionally, the target pictures sequentially displayed may be formed of an electronic album.

Optionally, the material information carried in the target material identity information may be target style information. In this regard, the client may perform a target style conversion on the target pictures sequentially displayed by using the target style information, so that the target pictures in the electronic album obtained after conversion are presented in a unified style, for example, all are in a gray-white style.

Optionally, the material information carried in the target material identity information may be target music information. In this regard, the client may perform a music picture splicing on the target pictures displayed sequentially by using the target music information, so that music along with the electronic album after adding music may be played while playing the electronic album.

In the embodiments of the present disclosure, the client may display resource information of the current subtask on the subtask display page. Optionally, in response to a publishing instruction of the generated work, the client may publish the generated work, and receive a virtual resource described in the resource information of the current subtask.

FIG. 9 is a block diagram illustrating an apparatus for processing a task according to an exemplary embodiment. The apparatus has a function of implementing the above method for processing data in the above method embodiments, which may be implemented by a hardware, or implemented by executing a corresponding software by the hardware. As illustrated in FIG. 9, the apparatus includes a first display module 901 and a second display module 902.

The first display module 901 is configured to display a subtask display page in response to a display instruction of a current subtask in a target task. The subtask display page includes a plurality of pieces of material identity information. The plurality of pieces of material identity information include material identity information corresponding to a first picture type and material identity information corresponding to a second picture type. The material identity information corresponding to the first picture type indicates that an object to be captured is captured by an object capturing assembly for picture acquisition. The material identity information corresponding to the second picture type indicates that a target picture is acquired from a picture storage region.

The second display module 902 is configured to in response to an operation instruction corresponding to target material identity information in the plurality of pieces of material identity information, display a generated work of the current subtask on the subtask display page.

The generated work includes material information carried in the target material identity information and the object to be captured, or the generated work includes material information carried in the target material identity information and the target picture.

In some embodiments, when the target material identity information is the material identity information corresponding to the first picture type, the second display module is configured to perform:
in response to the operation instruction corresponding to the target material identity information in the plurality of pieces of material identity information, displaying the object to be captured in a first preview area of the subtask display page, and displaying material information carried in the target material identity information in a second preview area of the subtask display page;
in response to an adjustment instruction of a target sub-object in the object to be captured, displaying an adjusted object to be captured in the first preview area; and
in response to a work generating instruction, displaying a generated work including the material information and the adjusted object to be captured in the subtask display page.

In some embodiments, the second display module is further configured to perform:
in response to the operation instruction corresponding to the target material identity information in the plurality of pieces of material identity information, jumping from the subtask display page to a work example page;
displaying a capturing assembly and published works corresponding to different accounts on the work example page, in which the published works corresponding to the different accounts are generated based on the target material identity information; and
in response to a capturing instruction triggered based on the capturing assembly, displaying the object to be captured in the first preview area of the subtask display page.

In some embodiments, the apparatus further includes a display adjustment module configured to perform:
in response to detecting a pose adjustment of the object to be captured, determining a continuously adjusted display position of the first preview area in the subtask display page and a continuously adjusted material display perspective in a pose adjustment process;
displaying the first preview area in the continuously adjusted display position, and displaying the object to be captured in the first preview area; and displaying the material information carried in the target material identity information at the continuously adjusted material display perspective in the second preview area.

In some embodiments, when the target material identity information is the material identity information corresponding to the second picture type, the second display module is configured to perform:
in response to the operation instruction corresponding to the target material identity information in the plurality of pieces of material identity information, jumping from the subtask display page to a picture display page of a client;
displaying a plurality of historical pictures acquired at a historical moment in the picture display page; and
in response to an application instruction corresponding to the target picture in the plurality of historical pictures, displaying the target picture on the subtask display page in an application sequence of the target picture.

In some embodiments, the first display module is configured to perform:
in response to the display instruction of the current subtask in the target task, displaying the subtask display page;
displaying subtask description information of the current subtask on the subtask display page;
determining subtask key data of the current subtask by performing an information analysis on the subtask description information;
determining a plurality of pieces of material identity information from the material identity information library based on the subtask key data; and
displaying the plurality of pieces of material identity information on the subtask display page.

In some embodiments, the first display module is configured to perform:
determining a historical subtask in the target task, in which the historical subtask is a subtask before the current subtask;
determining historical material identity information applied in the historical subtask;
determining a plurality of pieces of candidate material identity information from the material identity information library based on the subtask key data; and
in response to the plurality of pieces of candidate material identity information including the historical material identity information, obtaining the plurality of pieces of material identity information by performing a material deletion on the plurality of pieces of candidate material identity information.

The plurality of pieces of material identity information do not include the historical material identity information.

In some embodiments, the apparatus further includes a task publishing module configured to perform:
displaying resource information of the current subtask on the subtask display page;
in response to a publishing instruction of the generated work, publishing the generated work; and
receiving a virtual resource described in the resource information of the current subtask.

It should be noted that, when the apparatus according to the above embodiments implement its function, only a division of the above function modules is illustrated. In practical applications, allocation of the above functions may be completed by different function modules according to requirements, that is, an internal structure of the device is divided into different function modules to complete all or part of functions described above. In addition, the apparatus according to the embodiment and the method embodiment belong to the same concept. For the detailed implementation process, please refer to the method embodiment, which is not repeated here.

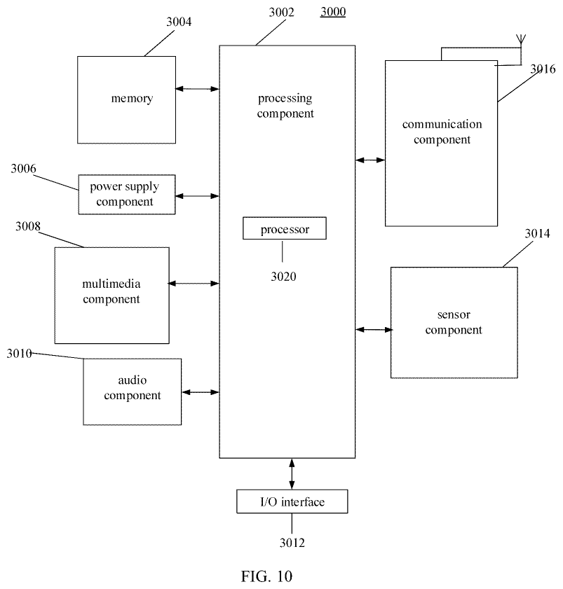

FIG. 10 is a block diagram illustrating a device 3000 for processing a task according to an exemplary embodiment. For example, the device 3000 may be a mobile phone, a computer, a digital broadcasting terminal, a messaging device, a game console, a tablet device, a medical equipment, a fitness equipment, a personal digital assistant, etc.

As illustrated in FIG. 10, the device 3000 may include one or more components: a processing component 3002, a memory 3004, a power supply component 3006, a multimedia component 3008, an audio component 3010, an input/output (I/O) interface 3012, a sensor component 3014, and a communication component 3016.

The processing component 3002 generally controls the whole operations of the device 3000, such as operations related to display, phone call, data communication, a camera operation and a recording operation. The processing component 3002 may include one or more processors 3020 to perform instructions, to complete all or part of steps of the above method. In addition, the processing component 3002 may include one or more modules for the convenience of interactions between the processing component 3002 and other components. For example, the processing component 3002 may include a multimedia module for the convenience of interaction between the multimedia component 3008 and the processing component 3002.

The memory 3004 is configured to store all picture types of data to support the operations of the device 3000. Examples of the data include the instructions of any APPs or methods operated on the device 3000, contact data, phone book data, messages, pictures, videos, etc. The memory 3004 may be implemented by any picture type of volatile or non-volatile storage devices or their combination, such as a static random access memory (SRAM), an electrically erasable programmable read-only memory (EEPROM), an erasable programmable read-only (EPROM), a programmable read-only memory (PROM), a read-only memory (ROM), a magnetic memory, a flash memory, a magnetic disk or an optical disk.

The power supply component 3006 may provide power supply for all components of the device 3000. The power supply component 3006 may include power supply management system, one or more power supplies, and other units related to generating, managing and distributing power for the device 3000.

The multimedia component 3008 includes an output interface screen provided between the device 3000 and the user. In some embodiments, the screen may include a liquid crystal display (LCD) and a touch panel (TP). When the screen includes a touch panel, the screen may be implemented as a touch screen to receive input signals from the user. The touch panel includes one or more touch sensors to sense touches, slides and gestures on the touch panel. The touch sensor may not only sense the boundary of touch or slide actions, but also detect the duration and pressure related to the touch or slide operations. In some embodiments, the multimedia component 3008 includes a front camera and/or a rear camera. When the device 3000 is in an operation mode, such as a shooting mode or a video mode, the front camera or the rear camera may receive the external multimedia data. Each of the front camera and rear camera may be a fixed optical lens system or an optical lens system with a focal length and an optical zoom capacity.

The audio component 3010 is configured to output and/or input audio signals. For example, the audio component 3010 includes a microphone (MIC). When the device 3000 is in the operation mode, such as a call mode, a record mode, and a speech recognition mode, the microphone is configured to receive external audio signals. The audio signals received may be further stored in the memory 3004 or sent via the communication component 3016. In some embodiments, the audio component 3010 further includes a speaker configured to output an audio signal.

The I/O interface 3012 provides an interface for the processing component 3002 and a peripheral interface module, and the peripheral interface module may be a keyboard, a click wheel, a button, etc. The buttons may include but not limited to a home button, a volume button, a start button and a lock button.

The sensor component 3014 includes one or more sensors, configured to provide various aspects of status assessment for the device 3000. For example, the sensor component 3014 may detect an on/off state of the device 3000 and a relative positioning of the component. For example, the component is a display and a keypad of the device 3000. The sensor component 3014 may further detect a location change of the device 3000 or one component of the device 3000, a presence or absence of contacts between the user and the device 3000, an orientation or acceleration/deceleration of the device 3000, and a temperature change of the device 3000. The sensor component 3014 may include a proximity sensor, which is configured to detect presence of the objects nearby without any physical contact. The sensor component 3014 may further include a light sensor such as CMOS or CCD image sensor, which is configured to use in imaging applications. In some embodiments, the sensor component 3014 may further include an acceleration transducer, a gyroscope sensor, a magnetic sensor, a pressure sensor or a temperature sensor.

The communication component 3016 is configured for the convenience of wire or wireless communication between the device 3000 and other devices. The device 3000 may access wireless networks based on a communication standard, such as WiFi, an operator network (2G, 3G, 4G or 5G), or their combination. In an exemplary embodiment, the communication component 3016 receives broadcast signals or broadcast-related information from an external broadcast management system via a broadcast channel. In an exemplary embodiment, the communication component 3016 further includes a near field communication (NFC) module to facilitate short-range communication. For example, an NFC module may be implemented based on a radio frequency identification (RFID) technology, an infrared data association (IRDA) technology, an ultra-wideband (UWB) technology, bluetooth (BT) technology and other technologies.

In an exemplary embodiment, the device 3000 may be implemented by one or more application specific integrated circuits (ASIC), digital signal processors (DSP), digital signal processing devices (DSPD), programmable logic devices (PLD), field programmable gate arrays (FPGA), controllers, micro control units (MCU), microprocessors or other electronics components, which is configured to perform the above method.

A computer-readable storage medium is further provided in the embodiments of the disclosure. The computer-readable storage medium may be configured in an electronic device to store at least one instruction or at least one program related to the method for processing a task. The at least one instruction or the at least one program is loaded and executed by a processor to implement the method for processing a task processing according to the method embodiments.

In an exemplary embodiment, a storage medium including instructions is further provided, such as the memory 3004 including instructions. The instructions may be executed by the processor 3020 of the device 3000 to complete the above methods. Optionally, the storage medium may be a non-transitory computer readable storage medium, for example, the non-transitory computer readable storage medium may be a ROM, a random access memory (RAM), a CD-ROM, a magnetic tape, a floppy disk, an optical data storage device, etc.

A computer-readable storage medium is further provided in the embodiments of the present disclosure. When instructions of the computer-readable storage medium are executed by a processor of an electronic device, the electronic device is caused to perform the method as described in any one of the first aspect of the embodiments of the present disclosure.

A computer program product is provided in the embodiments of the present disclosure. The computer program product includes a computer program stored in a readable storage medium. When at least one processor of a computer device reads and executes the computer program from the readable storage medium, the computer device is caused to perform the method as described in any one of the first aspect of the embodiments of the present disclosure.

It needs to be noted that a sequential order of the above embodiments is only for the purpose of description and does not represent advantages and disadvantages of the embodiments. The particular embodiments of the disclosure are described above. Other embodiments are within the scope of appended claims. In some cases, actions or steps recorded in claims may be executed in a sequence different from that in the embodiments and may still achieve a desired result. In addition, a process depicted in the accompanying drawings does not necessarily require a specific sequence or a sequential sequence to achieve the desired result. In certain implementations, multitasking processing and parallel processing may be or might be advantageous.

Embodiments in the description are described in a progressive manner, where the same and similar parts between the embodiments may be referred to each other. Each embodiment focuses on its differences from other embodiments. Particularly, since the apparatus embodiments are similar to the method embodiments, descriptions of the apparatus embodiments refer to a part of descriptions of the method embodiments.

Those skilled in the art may understand that all or part of the steps in the above embodiments may be implemented by a hardware, or by a program(s) to instruct relevant hardware, in which the program may be stored in the computer readable storage medium which may be a read-only memory, a magnetic disk or an optical disk, etc.

The above embodiments of the present disclosure do not constitute a limitation of the present disclosure. Any modification, equivalent replacement, improvement, etc., made within the principle of embodiments of the present disclosure shall be included within the protection scope of embodiments of the disclosure.

What is claimed is:

1. A method for processing a task, performed by an electronic device, the method comprising:
in response to receiving a display instruction of a current subtask in a target task, displaying a subtask page, wherein the subtask page comprises a plurality of pieces of material identity information, the plurality of pieces of material identity information comprise first material identity information corresponding to a first picture type and second material identity information corresponding to a second picture type, the first material identity information indicates that an object to be captured is captured by a capturing assembly for picture acquisition, and the second material identity information indicates that a target picture is acquired from a picture storage region; and
in response to receiving an operation instruction corresponding to target material identity information in the plurality of pieces of material identity information, displaying a generated work of the current subtask on the subtask page;
wherein the generated work comprises material information carried in the target material identity information and the object to be captured, or the generated work comprises material information carried in the target material identity information and the target picture.

2. The method according to claim 1, wherein when the target material identity information is the first material identity information, displaying the generated work of the current subtask on the subtask page comprises:
in response to receiving the operation instruction corresponding to the target material identity information in the plurality of pieces of material identity information, displaying the object to be captured in a first preview area of the subtask page, and displaying material information carried in the target material identity information in a second preview area of the subtask page;
in response to receiving an adjustment instruction of a target sub-object in the object to be captured, displaying an adjusted object to be captured in the first preview area; and
in response to receiving a work generating instruction, displaying a generated work comprising the material information and the adjusted object to be captured in the subtask page.

3. The method according to claim 2, wherein displaying the object to be captured in the first preview area of the subtask display page comprises:
in response to receiving the operation instruction corresponding to the target material identity information in the plurality of pieces of material identity information, jumping from the subtask page to a work example page;
displaying the capturing assembly and published works corresponding to different accounts on the work example page, wherein the published works corresponding to the different accounts are generated based on the target material identity information; and
in response to receiving a capturing instruction triggered based on the capturing assembly, displaying the object to be captured in the first preview area of the subtask page.

4. The method according to claim 2, further comprising:
in response to detecting a pose adjustment of the object to be captured, determining a continuously adjusted display position of the first preview area in the subtask page and a continuously adjusted material display perspective in a pose adjustment process;
displaying the first preview area in the continuously adjusted display position, and displaying the object to be captured in the first preview area; and
displaying the material information carried in the target material identity information at the continuously adjusted material display perspective in the second preview area.

5. The method according to claim 1, wherein when the target material identity information is the second material identity information, displaying the generated work of the current subtask on the subtask display page comprises:
in response to receiving the operation instruction corresponding to the target material identity information in the plurality of pieces of material identity information, jumping from the subtask page to a picture page of the electronic device;
displaying a plurality of historical pictures acquired at a historical moment in the picture page; and
in response to receiving an application instruction corresponding to the target picture in the plurality of historical pictures, displaying the target picture on the subtask page in an application sequence of the target picture.

6. The method according to claim 1, wherein displaying the subtask page comprises:
in response to receiving the display instruction of the current subtask in the target task, displaying the subtask page;
displaying subtask description information of the current subtask on the subtask page;
determining subtask key data of the current subtask by performing an information analysis on the subtask description information;
determining the plurality of pieces of material identity information from a material identity information library based on the subtask key data; and
displaying the plurality of pieces of material identity information on the subtask page.

7. The method according to claim 6, wherein determining the plurality of pieces of material identity information from the material identity information library based on the subtask key data comprises:
determining a historical subtask in the target task, wherein the historical subtask is a subtask before the current subtask;
determining historical material identity information applied in the historical subtask;
determining a plurality of pieces of candidate material identity information from the material identity information library based on the subtask key data; and
in response to the plurality of pieces of candidate material identity information comprising the historical material identity information, obtaining the plurality of pieces of material identity information by deleting the historical material identity information from the plurality of pieces of candidate material identity information.

8. The method according to claim 6, further comprising:
displaying resource information of the current subtask on the subtask page;
in response to receiving a publishing instruction of the generated work, publishing the generated work; and
receiving a virtual resource described in the resource information of the current subtask.

9. An electronic device, comprising:
a processor; and
a memory for storing instructions executable by the processor;
wherein the processor is configured to:
in response to receiving a display instruction of a current subtask in a target task, display a subtask page, wherein the subtask page comprises a plurality of pieces of material identity information, the plurality of pieces of material identity information comprise first material identity information corresponding to a first picture type and second material identity information corresponding to a second picture type, the first material identity information indicates that an object to be captured is captured by a capturing assembly for picture acquisition, and the second material identity information indicates that a target picture is acquired from a picture storage region; and
in response to receiving an operation instruction corresponding to target material identity information in the plurality of pieces of material identity information, display a generated work of the current subtask on the subtask page, wherein the generated work comprises material information carried in the target material identity information and the object to be captured, or the generated work comprises material information carried in the target material identity information and the target picture.

10. The electronic device according to claim 9, wherein when the target material identity information is the first material identity information, the processor is further configured to:
in response to receiving the operation instruction corresponding to the target material identity information in the plurality of pieces of material identity information, display the object to be captured in a first preview area of the subtask page, and display material information carried in the target material identity information in a second preview area of the subtask page;
in response to receiving an adjustment instruction of a target sub-object in the object to be captured, display an adjusted object to be captured in the first preview area; and
in response to receiving a work generating instruction, display a generated work comprising the material information and the adjusted object to be captured in the subtask page.

11. The electronic device according to claim 10, wherein the processor is further configured to:
in response to receiving the operation instruction corresponding to the target material identity information in the plurality of pieces of material identity information, jump from the subtask page to a work example page;
display the capturing assembly and published works corresponding to different accounts on the work example page, wherein the published works corresponding to the different accounts are generated based on the target material identity information; and
in response to receiving a capturing instruction triggered based on the capturing assembly, display the object to be captured in the first preview area of the subtask page.

12. The electronic device according to claim 10, wherein the processor is further configured to
in response to detecting a pose adjustment of the object to be captured, determine a continuously adjusted display position of the first preview area in the subtask page and a continuously adjusted material display perspective in a pose adjustment process;
display the first preview area in the continuously adjusted display position, and display the object to be captured in the first preview area; and
display the material information carried in the target material identity information at the continuously adjusted material display perspective in the second preview area.

13. The electronic device according to claim 9, wherein when the target material identity information is the second material identity information, the processor is further configured to:
in response to receiving the operation instruction corresponding to the target material identity information in the plurality of pieces of material identity information, jump from the subtask page to a picture page of the mobile terminal;
display a plurality of historical pictures acquired at a historical moment in the picture page; and
in response to receiving an application instruction corresponding to the target picture in the plurality of historical pictures, display the target picture on the subtask page in an application sequence of the target picture.

14. The electronic device according to claim 9, wherein the processor is further configured to:
in response to receiving the display instruction of the current subtask in the target task, display the subtask page;
display subtask description information of the current subtask on the subtask page;
determine subtask key data of the current subtask by performing an information analysis on the subtask description information;
determine the plurality of pieces of material identity information from a material identity information library based on the subtask key data; and
display the plurality of pieces of material identity information on the subtask page.

15. The electronic device according to claim 14, wherein the processor is further configured to:
determine a historical subtask in the target task, wherein the historical subtask is a subtask before the current subtask;
determine historical material identity information applied in the historical subtask;
determine a plurality of pieces of candidate material identity information from the material identity information library based on the subtask key data; and
in response to the plurality of pieces of candidate material identity information comprising the historical material identity information, obtain the plurality of pieces of material identity information by deleting the historical material identity information from the plurality of pieces of candidate material identity information.

16. The electronic device according to claim 15, wherein the processor is further configured to:
display resource information of the current subtask on the subtask page;
in response to receiving a publishing instruction of the generated work, publish the generated work; and
receive a virtual resource described in the resource information of the current subtask.

17. A non-transitory computer-readable storage medium having instructions stored thereon which, are executed by a processor of an electronic device, the electronic device is caused to perform the a method for processing a task, the method comprising:
in response to receiving a display instruction of a current subtask in a target task, displaying a subtask page, wherein the subtask page comprises a plurality of pieces of material identity information, the plurality of pieces of material identity information comprise first material identity information corresponding to a first picture type and second material identity information corresponding to a second picture type, the first material identity information indicates that an object to be captured is captured by a capturing assembly for picture acquisition, and the second material identity information indicates that a target picture is acquired from a picture storage region; and
in response to receiving an operation instruction corresponding to target material identity information in the plurality of pieces of material identity information, displaying a generated work of the current subtask on the subtask page;
wherein the generated work comprises material information carried in the target material identity information and the object to be captured, or the generated work comprises material information carried in the target material identity information and the target picture.

18. The non-transitory computer-readable storage medium according to claim 17, wherein when the target material identity information is the first material identity information, displaying the generated work of the current subtask on the subtask page comprises:
in response to receiving the operation instruction corresponding to the target material identity information in the plurality of pieces of material identity information, displaying the object to be captured in a first preview area of the subtask page, and displaying material information carried in the target material identity information in a second preview area of the subtask page;
in response to receiving an adjustment instruction of a target sub-object in the object to be captured, displaying an adjusted object to be captured in the first preview area; and
in response to receiving a work generating instruction, displaying a generated work comprising the material information and the adjusted object to be captured in the subtask page.

19. The non-transitory computer-readable storage medium according to claim 18, wherein displaying the object to be captured in the first preview area of the subtask display page comprises:
in response to receiving the operation instruction corresponding to the target material identity information in the plurality of pieces of material identity information, jumping from the subtask page to a work example page;
displaying the capturing assembly and published works corresponding to different accounts on the work example page, wherein the published works corresponding to the different accounts are generated based on the target material identity information; and
in response to receiving a capturing instruction triggered based on the capturing assembly, displaying the object to be captured in the first preview area of the subtask page.

20. The non-transitory computer-readable storage medium according to claim 18, wherein the method further comprises:
in response to detecting a pose adjustment of the object to be captured, determining a continuously adjusted display position of the first preview area in the subtask page and a continuously adjusted material display perspective in a pose adjustment process;
displaying the first preview area in the continuously adjusted display position, and displaying the object to be captured in the first preview area; and
displaying the material information carried in the target material identity information at the continuously adjusted material display perspective in the second preview area.
